(19) United States
(12) Patent Application Publication
(10) Pub. No.: US 2020/0374720 A1
(43) Pub. Date: Nov. 26, 2020

(54) Method for Detecting Abnormal Data in Sensor Network

(71) Applicant: Jiangnan University, Wuxi (CN)

(72) Inventors: Guanghui LI, Wuxi (CN); Ouyang XU, Wuxi (CN)

(21) Appl. No.: 16/993,454

(22) Filed: Aug. 14, 2020

Related U.S. Application Data
(63) Continuation of application No. PCT/CN2019/082673, filed on Apr. 15, 2019.

(30) Foreign Application Priority Data
Jun. 4, 2018 (CN) 201810563300.9

(51) Int. Cl. H04W 24/04; G06N 20/20; G06N 5/00; G06N 5/04

(52) U.S. Cl. CPC H04W 24/04; G06N 20/20; H04W 84/18; G06N 5/04; G06N 5/003

(57) ABSTRACT

The disclosure discloses a method for detecting abnormal data in a sensor network, belonging to the field of detection of data reliability of a WSN. The method includes: modeling an isolated tree set iforest in a certain scale by means of historical data sets collected by sensor nodes based on an isolation forest algorithm, introducing information of the distance between samples to be tested and various sample centers thereof to each of leaf nodes, setting weight coefficients of the isolated trees in combination with diversity measure, modeling a weighted hybrid isolation forest Whiforest, and finally, determining anomalies of WSN data by means of the improved weighted hybrid isolation forest Whiforest model. The weight coefficients are set based on different contributions made by each of the trees in the forest to the computation of the final anomaly score. Therefore, compared with a traditional iforest model, the accuracy of anomaly detection is improved.

### TECHNICAL FIELD

The disclosure relates to a method for detecting abnormal data in a wireless sensor network (WSN), belonging to the field of detection of data reliability of the WSN.

### BACKGROUND

WSN is a wireless network composed of a large number of stationary or mobile sensors in self-organizing and multi-hop manners. The sensors cooperatively sense, collect, process and transmit the information of the sensed objects in the geographical area covered by the network, and finally send the information to the owner of the network. The data, serving as a carrier for carrying the information of the sensed objects in WSN, contains a lot of useful information. In the process of collecting data, the sensors are susceptible to various types of noises or events in the environment, including node faults, environmental noises, external attacks, etc. They all have influence on the data collected by nodes, which causes an incorrect monitored environmental state. In order to ensure that WSN can accurately reflect the monitored environmental state, it is usually necessary to use various anomaly detection technologies to find out the abnormal data.

The existing anomaly detection solutions for WSN include centralized solution and distributed solution. The centralized solution requires that each node transmit its data to the sink node, so the robustness of this solution is poor. In order to improve the robustness of the network and prolong the life cycle of the network, the distributed solution allows each node to automatically detect the abnormal data, but each node only detects the abnormal data according to the model established by itself, so the false alarm ratio is higher and the detection accuracy is also lower.

The isolation forest algorithm proposed by F. T. Liu, et al has been widely used in data anomaly detection. The algorithm builds an isolated tree ensemble model using historical data sets, computes its anomaly scores s(Y) based on the average search depth of the samples under test, sorts the anomaly scores of the currently detected sample set in a descending order, and takes a certain number of the samples as the detected abnormal values, so as to determine whether it is abnormal or not. The method has the advantages of simple principle, lower algorithm complexity and ideal detection accuracy, but has lower applicability to anomaly detection of some concave data sets. That is, when there is a partial intersection between normal data points and abnormal data points, at this time, the principle that the shorter the detection path length is, the greater the anomaly score is will result in a poor detection effect, and the fact that the contribution of each of the trees in the forest to the computation of the final anomaly score should be different is ignored. The method has not been seen in the detection application of the abnormal data in the WSN.

### SUMMARY

In order to solve the problems that the existing isolation forest algorithm has lower applicability to anomaly detection of concave data sets and does not distinguish the contribution of each of the trees in the forest to the computation of the final anomaly score, the disclosure provides a method for detecting abnormal data in a WSN. The method includes:

modeling an isolated tree set iforest by means of historical data sets based on an isolation forest algorithm; introducing information of the distance between samples to be tested and various sample centers thereof to each of leaf nodes of each of isolated trees in the isolated tree set iforest; and setting weight coefficients of each of the isolated trees in combination with diversity measure, modeling a weighted hybrid isolation forest Whiforest, and determining anomalies of WSN data in the samples under tested by means of the Whiforest model.

Optionally, before modeling an isolated tree set iforest by means of historical data sets based on an isolation forest algorithm, the method further includes:

dividing the historical data sets into training sets and test sets.

Optionally, the process of modeling an isolated tree set iforest by means of historical data sets based on an isolation forest algorithm, introducing information of the distance between samples to be tested and various sample centers thereof to each of the leaf nodes of each of isolated trees in the isolated tree set iforest, setting weight coefficients of each of the isolated trees in combination with diversity measure, and modeling a weighted hybrid isolation forest Whiforest includes:

step 1: modeling each of the isolated trees in the isolated tree set iforest by means of the data of the training sets in the historical data sets, including setting a parameter bootstrap sampling number ψ, a forest scale T, a weight coefficient threshold μ, a size of a verification sample set Val_W and a known abnormal sample injection ratio;

step 2: randomly choosing known abnormal samples according to the given abnormal sample injection ratio, and injecting the chosen known abnormal samples to each isolated tree in the iforest;

step 3: computing a training sample center Cen-s in the leaf nodes of each tree and a distance δ(x) between each sample x to be tested in the leaf nodes and the Cen-s, and computing the mean s_{c}(x) of the distance δ(x) in each of the trees in the forest:

s_{c}(x)=E(δ(x))

step 4: computing an abnormal sample center Cen-a in the leaf nodes, computing the distance δₐ(x) between each sample x under tested in the leaf nodes and the Cen-a, and computing a ratio sₐ(x) of the mean of δ(x) to the mean of δₐ(x) in all isolated trees:

$${s}_{a} ( x ) = \frac{E ( δ ( x ) )}{E ( {δ}_{a} ( x ) )} = \frac{{Mean}_{iforest} ( δ ( x ) )}{{Mean}_{iforest} ( {δ}_{a} ( x ) )}$$

step 5: choosing verification sample sets Val-W according to the historically collected data sets, detecting the verification sample sets Val-W by the above established isolated tree set iforest, and computing the diversity between the isolated trees in the forest by means of disagreement measure in combination with the idea of the diversity of base classifiers in ensemble learning, so as to obtain a T*T symmetric matrix diversity of which the opposite angles are 0, wherein T represents the number of the isolated trees in the isolated tree set iforest;

step 6: summing up the diversity matrix and making a quotient according to a forest scale T to obtain B_{index}, at this time, comparing the B_{index} with the threshold μ, and setting weights as follows:

$$W = \{ \begin{matrix}{B}_{index} + 1 , & if B \geq μ \\ 1 - {B}_{index} , & if B < μ\end{matrix}$$

step 7: setting the weight w1=B_{index}+1 for the tree of which the B_{index} is greater than or equal to μ, setting the weight w2=1−B_{index} for the tree of which the B_{index} is less than μ, multiplying both s_{c}(x) and sₐ(x) variables by w1 and w2, and computing s_{c}(x) and sₐ(x) by the following formulae:

s_{c}(x)=W*δ(x)

δₐ(x)=W*δₐ(x)

step 8: normalizing the original Score(x) of the sample in a current data window and two currently introduced distance-based scores, i.e. {Score,sₐ(x),s_{c}(x)}, by the following normalization formula:

$$\tilde{s} ( x ) = \frac{s ( x ) - min ( s ( x ) )}{max ( s ( x ) ) - min ( s ( x ) )}$$

wherein s(x )represents the above three scores Score, sₐ(x), s_{c}(x), \tilde{s}(x) represents a normalized value, and finally, the above three scores are fused by the following formula to obtain a final window sample anomaly score s_{final}:

s_{final}(x)=α₂*(α₁*\tilde{s}s(x)+(1−α₁)*\tilde{s}s_{c}(x))+(1−α₂)*\tilde{s}sₐ(x)

step 9: sorting the s_{final} in a descending order, obtaining a data sample having the highest anomaly score according to domain knowledge or referring to the known anomaly number ratio of the original data set, then comparing the data sample with the label of the tested data sample, and computing evaluation indexes related to a detection ratio and a false alarm ratio; and

step 10: if a node detects an abnormal sample in a data window, transmits the sequence number of the abnormal sample to a cluster head node for performing the subsequent verification or processing.

Optionally, in step 4, if a leaf node has no abnormal sample, the abnormal sample center Cen-a is marked as 0.

Optionally, in step 6, summation of the diversity matrix is summation of columns of the diversity matrix.

Optionally, in step 1, a termination condition for modeling of the isolated trees is as follows: samples can not be divided, i.e., only one data value is included, or data samples are exactly the same, or the depth of the isolated trees reaches the maximum log(ψ) wherein ψ represents a parameter bootstrap sampling number.

Optionally, in step 8, the original Score(x) of the sample in the current data window is computed according to the following formula:

$$Score ( x ) = {2}^{- \frac{E ( h ( x ) )}{C ( ψ )}}$$

wherein h(x) represents the path length of the data sample x on a tree, and C(ψ) represents the mean search path length of Itree modeled with the sampling number ψ.

Optionally, the path length of the data sample x on a tree is h(x)=e+C(T.size), and C(T.size) represents the mean path length of a binary tree modeled with T.size pieces of data.

Another objective of the disclosure is to provide a method for monitoring an environment by a WSN. The WSN includes a lot of sensor nodes, the sensor nodes are dispersed in the environment to be monitored, and the method for monitoring an environment by a WSN adopts the above-mentioned anomaly detection method to detect the abnormal data, and remove the abnormal data to obtain the state of the monitored environment.

A data set collected by each of the sensor nodes in the WSN includes data of three attributes of temperature, humidity and light intensity.

Optionally, the historical data set collected by each of the sensor nodes further includes data of a node voltage attribute.

Another objective of the disclosure is to provide a computer device, including a memory, a processor and a computer program stored in the memory and capable of running on the processor. When the program is performed by the processor, the steps of the above method are implemented.

The disclosure has the following beneficial effects:

The isolated tree set iforest in a certain scale is modeled by means of the historical data sets collected by the sensor nodes based on the isolation forest algorithm, the information of the distance between the samples to be tested and various sample centers thereof is introduced to each of the leaf nodes, the weight coefficients of the isolated trees are set in combination with diversity measure, and finally, the anomalies of the WSN data are determined by means of the improved isolation forest algorithm. Through experiments on each of sensor node data sets, the results indicate that the method sets the weight coefficients based on different contributions made by each of the trees in the forest to the computation of the final anomaly score, so that the accuracy of anomaly detection is improved, and application prospects are broad. When the method is applied to environmental monitoring, because abnormal data is detected more accurately, only the abnormal data needs to be removed, and the monitored environmental state can be obtained according to the remaining data so as to more truly reflect the environmental state of the monitored environment.

### BRIEF DESCRIPTION OF FIGURES

In order to more clearly illustrate the technical solutions in the embodiments of the disclosure, the accompanying drawings required for description of the embodiments will be briefly introduced below. It is apparent that the accompanying drawings in the following description are only some embodiments of the disclosure. Those skilled in the art can also obtain other drawings according to these accompanying drawings without any creative work.

FIG. 1 is a schematic flow diagram of a method for detecting abnormal data in a WSN provided by the present application.

FIG. 2 is a schematic diagram I of an artificial global dataset (AGD) in a method for detecting abnormal data in a WSN based on a weighted hybrid isolation forest.

FIG. 3 is a schematic diagram II of an AGD in a method for detecting abnormal data in a WSN based on a weighted hybrid isolation forest.

FIG. 4 is an anomaly score diagram of a traditional iforest model in a method for detecting abnormal data in a WSN based on a weighted hybrid isolation forest.

FIG. 5 is an anomaly score diagram of a Whiforest model in a method for detecting abnormal data in a WSN based on a weighted hybrid isolation forest.

### DETAILED DESCRIPTION

In order to make the objectives, technical solutions and advantages of the disclosure more clear, the embodiments of the disclosure will be further described in detail below with reference to the accompanying drawings.

The present application proposes a method for detecting abnormal data in a WSN by improving an isolation forest algorithm. The method detects abnormal data in the WSN based on a weighted hybrid isolation forest (Whiforest): firstly, an isolated tree set iforest in a certain scale is modeled based on the isolation forest algorithm, the information of the distance between the samples to be tested and various sample centers thereof is introduced to each of the leaf nodes, weight coefficients of the isolated trees are set in combination with diversity measure, and finally, anomalies of WSN data are determined by means of the improved isolation forest algorithm. To further clarify the principles and innovations of the method, firstly, some basic concepts are introduced:

1. Detection ratio refers to a ratio of the number of abnormal data samples detected by the algorithm to the total number of abnormal data samples actually contained in the data set.

2. False alarm ratio refers to a ratio of the number of normal data samples misjudged as abnormal data samples by the algorithm to the total number of the normal data samples.

3. Data window refers to that when anomaly detection is performed, the data within the latest period of time is usually selected, and a sliding window with a fixed length is used as a data block for detection processing of sensor data.

4. Termination condition for modeling of the isolated trees is as follows: samples can not be divided, that is, only one data value is included, or data samples are exactly the same, or the depth of the isolated trees reaches the maximum log(ψ) wherein ψ represents a data sampling number of root nodes of the isolated trees.

5. Search path depth h(x) represents the path length of the data sample x on the isolated tree, wherein T.size represents the number of samples that fall on the same leaf node as x during training, and e represents the number of edges that the sample x passes from the root node to the leaf node.

h(x)=e+C(T.size)

6. Mean path length C(n) of the binary tree is the mean path length of the binary tree modeled with a certain amount of data, wherein H(n−1) can be estimated by In(n−1)+0.5772156649, and the following term is an Euler's constant e.

$$C ( n ) = 2 H ( n - 1 ) - \frac{2 ( n - 1 )}{n}$$

7. Detection of anomaly score Score(x): the final anomaly score Score(x) of the data sample to be tested is obtained by normalizing the mean path length E(h(x)) of the data x and the mean search path length C(ψ) of the tree modeled with the sampling number ψ.

$$Score ( x ) = {2}^{- \frac{E ( h ( x ) )}{C ( ψ )}}$$

1. Model Training Stage:

A certain number of isolation trees (Itree) are modeled by means of bootstrap self-service sampling, firstly, ψ data samples are collected from total training samples, a certain attribute (such as temperature and humidity) is randomly chosen as a root node, and at the same time, a random value is obtained between two extreme values (maximum value and minimum value) of this attribute, so that the samples in the root node that are less than this value are classified to its left child node, and those that are greater than or equal to this value are classified to its right child node; then, the left and right child nodes are respectively used as root nodes to perform recursive operations; and each of the trees is modeled sequentially according to the above operations so as to complete model training.

2. Stage of Detection of Sample to be Tested:

The anomaly score of each of data points is obtained in combination with the detection results of all isolated trees in the forest. The anomaly score of the sample x is determined by its search path depth h(x) in each Itree. The specific process is to search for x downward along the root node of an Itree according to different attributes and different values until reaching the leaf node.

The following uses two examples to understand the specific process of the isolation forest.

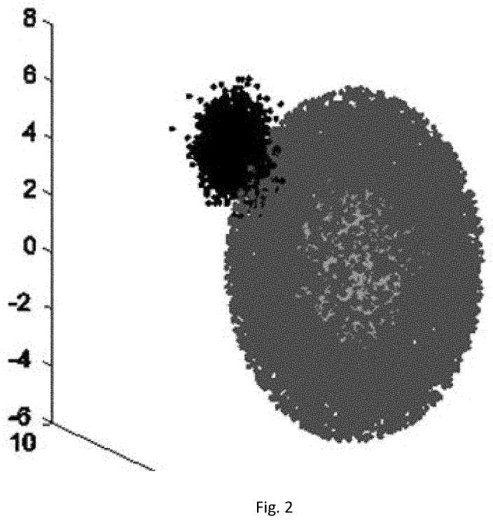

There is a set of one-dimensional data as shown in FIGS. 2-6 below. Our goal is to separate points A and B. The used manner is to randomly choose a value s between the maximum value and the minimum value (here, the attribute has only one dimension, regardless of the choice of the attribute), and then divide the data into left and right sets according to values less than s and greater than or equal to s. The above steps are performed recursively and stopped when the data samples can not be divided. It can be seen from the figures below that the position of the point B is approximately close to the edge relative to other data, so that only a few times are needed to isolate the point B; and the position of the point A is the overlapped part of most blue points, so that more times are needed to isolate the point A.

Now, for a two-dimensional data set, if two features are x and y respectively, they are randomly divided along two attribute axes in order to separate points C and D in FIGS. 2-7 below. Firstly, any one of x and y is randomly chosen, and the data is divided into left and right blocks according to the size relationship with the feature value by means of a processing manner for the one-dimensional data described above. It is still divided by means of the manner described above until it can not be subdivided. The expression that it can not be subdivided here refers to that there is only one data point left in the divided data, or the remaining data is exactly the same. Intuitively, it can be seen that the point D is relatively remote from other data points, so that only a few times of divisions are needed to separate the point D; and the position of the point C is approximately close to the central dense area of the data blocks, so that number of divisions required will be more.

Based on the above two examples, B and D are relatively far away from other data and are considered as abnormal data, while A and C are considered as normal data. The abnormal data is relatively remote than other data points intuitively and may be separated by fewer data space divisions, while the normal data is opposite to the abnormal data. This is the core working principle of the isolation forest.

### Embodiment 1

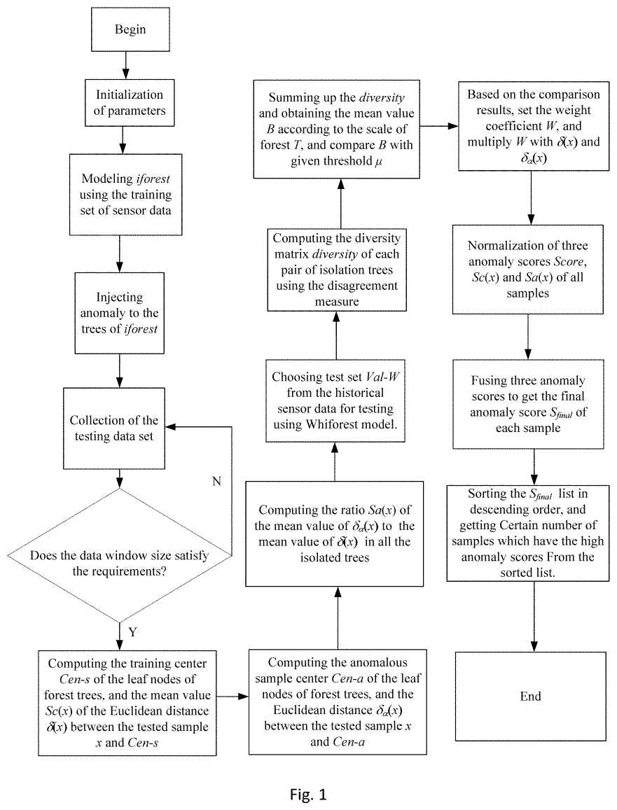

The present embodiment provides a method for detecting abnormal data in a WSN. Referring to FIG. 1, the method includes:

S1: Historical data sets collected by sensor nodes are divided into training sets and test sets respectively.

S2: An isolated tree set iforest is modeled by means of the training sets.

S3: A small number of known abnormal samples are manually injected to the model obtained in S2, and a Whiforest model is established based on weight coefficients obtained by diversity computation in the forest of fusion of two types of distance information of the leaf nodes of the isolated trees.

S4: For each of distributed nodes, when a certain number of new samples enter the data window, the trained Whiforest model is used to detect these new data to obtain an anomaly score and judge whether the data is abnormal.

S5: If there is an abnormal sample in S4, the detection result of the node on the data is transmitted to the cluster head node, so as to perform further subsequent operations.

Specifically, two definitions of information of the distance (i.e. s_{c}(x) and δₐ(x)) between the tested data samples and the centers of normal and abnormal data samples in the leaf nodes of the isolated trees are given respectively.

Definition 1: In the training stage, a training sample center Cen-s in the leaf nodes of each of the trees and the distance between each of the samples to be tested x in the leaf nodes and the above Cen-s are computed, and the mean s_{c}(x) of the distance in each of the trees in the forest is computed.

Definition 2: A small number of known abnormal samples are randomly chosen and injected to the trained Itrees, the abnormal sample center Cen-a in the leaf nodes is computed (if some leaf nodes have no abnormal samples, it will be marked as 0), and the distance δₐ(x) between each of the samples to be tested x in the leaf nodes and the above Cen-a is computed.

The proposed Whiforest algorithm further combines the idea of diversity of base classifiers in ensemble learning. When the isolation forest performs anomaly detection on the data, each of the trees will give an anomaly score to each of the samples to be tested. The algorithm sets the weights in combination with the diversity of each of the trees and the detection accuracy thereof, so that some trees with large diversity have greater control rights for the determination of the final anomaly index value.

Firstly, a certain number of samples Val-W are chosen and are detected by the trained isolation forest, the diversity between the trees in the forest is computed by means of the diversity scale, so as to obtain a T*T symmetric matrix diversity of which the opposite angles are 0, the columns of the diversity matrix are summed up and a quotient is made according to the forest scale T to obtain B_{index}, at this time, the B_{index} is compared with the threshold μ, the weights are set as formula (2), the weight is set to be w1=B_{index}+1 for the tree of which the B_{index} is greater than or equal to μ, the weight is set to be w2=1−B_{index} for the tree of which the B_{index} is less than μ, and several variables used later are multiplied by w1 and w2.

$$\begin{matrix}W = \{ \begin{matrix}{B}_{index} + 1 , & if B \geq μ \\ 1 - {B}_{index} , & if B < μ\end{matrix} & ( 2 ) \\ {s}_{c} ( x ) = W * δ ( x ) & ( 3 ) \\ {δ}_{a} ( x ) = W * {δ}_{a} ( x ) & ( 4 )\end{matrix}$$

After weighted W processing of δ(x) and δₐ(x), s_{c}(x), and sₐ(x) are computed by means of the above formulae (3) and (4), then, the original Score and two currently introduced distance-based scores, i.e., {Score,sₐ(x),sₐ(x)} are normalized (the used normalization formula is shown in formula (5) below, wherein s(x) represents the above three scores, and \tilde{s}(x) represents the normalized value), and finally, the three scores are fused by the formula (6) to obtain a final anomaly score S_{final}.

$$\begin{matrix}{s}^{\%} ( x ) = \frac{s ( x ) - min ( s ( x ) )}{max ( s ( x ) ) - min ( s ( x ) )} & ( 5 ) \\ {s}_{final} ( x ) = {α}_{2} * ( {α}_{1} * {s}^{\%} ( x ) + ( 1 - {α}_{1} ) * {{s}^{\%}}_{c} ( x ) ) + ( 1 - {α}_{2} ) * {{s}^{\%}}_{a} ( x ) & ( 6 )\end{matrix}$$

After the anomaly score S_{final} of the sample to be tested is obtained, firstly, the S_{final} is sorted in a descending order, a certain number of data samples having the highest anomaly score are obtained according to domain knowledge or referring to the known anomaly number ratio of the original data set, then the data samples are compared with the marks of the data samples to be tested, and evaluation indexes related to a detection ratio and a false alarm ratio are computed. The pseudo-codes of the Whisolation forest algorithm are as follows.

Algorithm design:

Algorithm 1: Whiforest (X-train, val-w, X-test, T, μ)

```
Input: Training data set X-train; tested data set X-test; Number T of
isolated trees included in ensemble model ; threshold μ;
Verification set val-w.
  1: All parameters of an algorithm are initialized.
  2: An initial detection model Model-if is trained by means of traditional
Hiforest.
  3: The verification set val-w is detected by means of the Model-if.
  4: Detection results of each of trees in the Model-if for the val-w are
obtained.
  5: The results are computed by means of disagreement measure to obtain
a diversity matrix diversity of each pair of isolated trees.
  6: The diversity is summed up, and a mean B is obtained according to a
forest scale T.
  7: Indexes index1 and index2 of each of the trees, greater than or equal
to and less than μ, are searched for.
  8: The weights W of T trees are respectively distributed.
  9: Intermediate variables that perform anomaly index polymerization
during detection all refer to the value of W.
10: Anomaly index scores are synthesized to give an anomaly detection
result.
Output: Detection result of Whiforest algorithm for X-test.
```

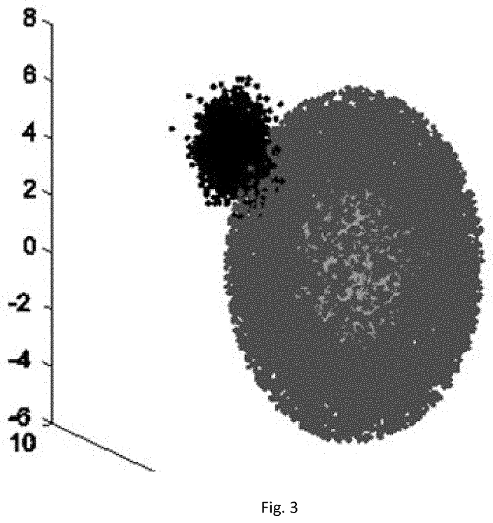

The algorithm has two relatively superior characteristics: 1) if the data sets are distributed as shown in FIG. 3, when the algorithm performs the detection, since the information of the distance between two centers of the leaf nodes is injected during computation of the anomaly score, the probability that the abnormal point at the normal sample center is missed is greatly reduced, and the detection ratio of this type of abnormal values is effectively improved; and 2) when no weight coefficient is injected, the detection of certain data samples by the algorithm will be affected by the decision results of some isolated trees with lower correlation in the forest, there is also a certain degree of negative effect on the detection results, and the Whiforest algorithm further improves the detection accuracy and reduces the false alarm ratio by means of disagreement measure and injection of weight coefficients.

### Embodiment 2

The present embodiment provides a method for monitoring an environment by a WSN. In the method for monitoring an environment by the WSN, the method for detecting abnormal data in a WSN, shown in embodiment 1, is used to detect the abnormal data in the data collected by each of the sensor nodes, and remove the abnormal data to obtain the state of the monitored environment.

The WSN includes a plurality of sensor nodes. When the WSN is used to monitor an environment, the plurality of sensor nodes are dispersed in the environment to be monitored to collect data. In the present embodiment, the data set collected by each of the sensor nodes contains data of three attributes of temperature, humidity and light intensity.

After a data stream sample formed by the data collected by each of the sensor nodes is obtained, by means of the data stream sample collected by the nodes of the WSN, firstly, an isolated tree set iforest in a certain scale is modeled based on the isolation forest algorithm, the information of the distance between the samples to be tested and various sample centers thereof is introduced to each of the leaf nodes, the weight coefficients of the isolated trees are set in combination with diversity measure, finally, the anomaly scores in the data sample sets of the WSN unit size are sorted in a descending order by means of an improved isolation forest algorithm, and the anomalies are determined in combination with the parameter ratio. The implementation examples of the method in specific data sets are given below.

The data samples come from the data collected by WSN nodes (IBRL) deployed in the Intel Berkeley Lab. The system contains 54 MICA2 sensor nodes, the data sampling period of each of the nodes is 30 s, and the features of the data collected by the sensor nodes include four attributes of temperature, humidity, light intensity and node voltage. Here, 7500 sets of temperature, humidity and light intensity measured by the node 25 in March, 2004 are chosen as sample data, wherein t represents a temperature data matrix, h represents a humidity data matrix, and l represents a light intensity data matrix:
t=[19.616, 19.449, −19.760, 19.145, −16.898, 18.933, −14.468, −13.527, −13.390 . . . 29.406, 18.606, 18.587, 18.557, 18.538, 18.498, 18.479, 18.479, 18.469 . . . 18.302, 18.322, 18.322, 18.322, 18.322, 18.312, 18.302, 18.302, 18.302 . . . 18.293, 18.263, 18.244, 18.263, 18.244, 18.234, 18.234, 18.224, 18.214 . . . 17.920, 17.930, 17.930, 17.921, 17.901, 17.901, 17.891, 17.891, 17.871 . . . 17.861, 17.861, 17.852, 17.842, 17.852, 17.832, 17.832, 17.823, 17.822 . . . ];
h=[37.573, 37.847, 22.465, 38.394, 22.538, 38.803, 22.685, 22.721, 22.685 . . . 23.051, 39.552, 39.552, 39.687, 39.687, 39.755, 39.755, 39.823, 40.026 . . . 40.060, 39.959, 39.959, 39.925, 39.959, 39.925, 39.925, 39.959, 39.891 . . . 39.959, 40.026, 40.026, 40.026, 40.026, 39.959, 40.026, 40.026, 40.060 . . . 40.162, 40.094, 40.094, 40.162, 40.094, 40.094, 40.263, 40.162, 40.196 . . . 40.229, 40.229, 40.229, 40.230, 40.2976, 40.196, 40.229, 40.229, 40.264 . . . ];
l=[97.52, 97.52, 0.46, 97.52, 0.46, 97.52, 0.46, 0.46, 0.46 . . . 0.46, 97.52, 101.2, 97.52, 97.52, 97.52, 97.52, 101.2, 97.52 . . . 97.52, 97.52, 97.52, 97.52, 97.52, 101.2, 97.52, 97.52, 97.52 . . . 101.2, 101.2, 101.2, 101.2, 101.2, 101.2, 101.2, 101.2, 101.2 . . . 97.52, 97.52, 97.52, 97.52, 101.2, 101.2, 101.2, 97.52, 101.2 . . . 101.2, 97.52, 97.52, 97.52, 97.52, 97.52, 97.52, 101.2, 101.2 . . . ];

The above t, h and l constitute a matrix D with a size of s rows and 3 columns, and here it is split into training data samples Train and test data samples Test by 3:1. The Train data set is used as input for training of the isolation forest, a small number of known abnormal samples are injected according to the domain knowledge in the training process to compute two distances, then, a verification sample set with a size of val-w is chosen, the forest is used to compute the disagreement measure value of each of the trees, and the weight coefficient is set for each of the isolated trees in the forest in combination with the detection accuracy and the weight coefficient threshold μ.

The forest model into which the information of the distance is introduced is used to detect the Test data set, the anomaly scores of size-t samples of the current unit size are sorted in a descending order, the first size-t*ratio data is taken as the abnormal data in the sample set of the current unit size in combination with the ratio, and subsequent data points with lower anomaly scores have normal values.

In order to reflect the advantages of the method shown in embodiment 1 on the concave data set, an experiment is additionally performed on an artificial global dataset, the number of attributes of the data set is 3, and the size of the chosen test data set is 15,000 and 21,000 respectively. The data distribution is roughly a concentric sphere with abnormal clusters in the center and on the edges, as shown in FIG. 3. In this experiment, the basic parameters for generating this data set are the distribution mean and covariance of center abnormal cluster and edge abnormal cluster samples, respectively expressed as: mea-center, mea-edge, cov-center and coy-edge. Specific parameter settings are shown in the table below.

TABLE 1
Specific parameters of AGD

| Data set | Mea-center | Mea-edge | Coy-center | Coy-edge |
|---|---|---|---|---|
| AGD1 | [0,0,0] | [−3,−3,−3] | [0.5,0,0;0,0.5,0;0,0,0.5] | [0.75,0,0;0,0.75,0;0,0,0.75] |
| AGD2 | [0,0,0] | [−3,−3,−3] | [0.5,0,0;0,0.5,0;0,0,0.5] | [0.75,0,0;0,0.75,0;0,0,0.75] |

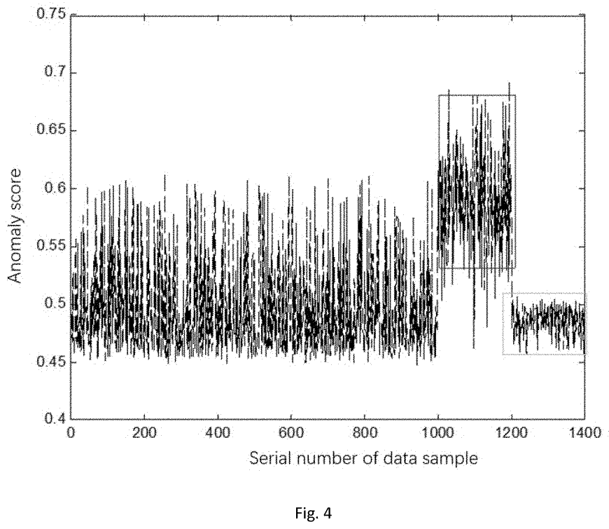

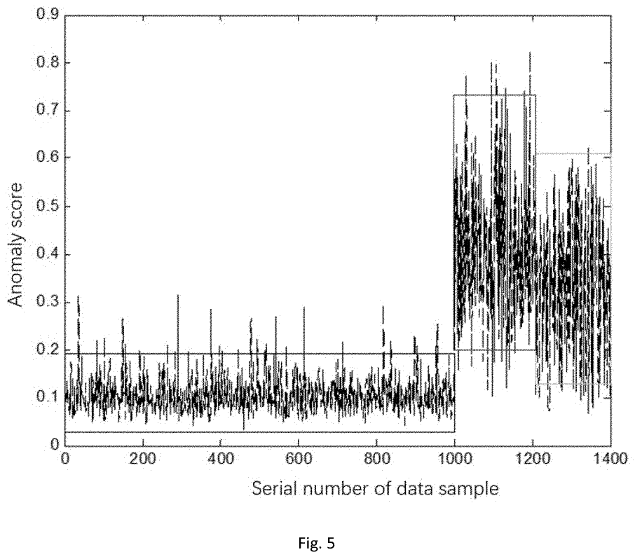

In specific detection processes, detection results of the chosen partial test data can refer to FIG. 4 and FIG. 5. It can be seen that the detection ratio of the algorithm in the disclosure for center abnormal points and edge abnormal points is significantly higher than that of the traditional isolation forest algorithm.

After the abnormal data is detected and removed, the environmental state of the monitored environment is obtained. The specific content of obtaining the environmental state according to the data after the abnormal data is removed is no longer traced. Those skilled in the art can complete the subsequent processes according to the existing method.

Some steps in the embodiments of the disclosure may be implemented by software, and corresponding software programs may be stored in a readable storage medium, such as an optical disk or a hard disk.

The above embodiments are merely preferred embodiments of the disclosure and are not intended to limit the disclosure. Any modification, equivalent replacement and improvement made within the spirit and principle of the disclosure are intended to be included within the protection scope of the disclosure.

What is claimed is:

1. A method for detecting abnormal data in a wireless sensor network (WSN), wherein the method comprises: modeling an isolated tree set iforest by means of historical data sets collected by sensor nodes based on an isolation forest algorithm; introducing information of a distance between samples to be tested and respective sample centers thereof to each of leaf nodes of each of isolated trees in the isolated tree set iforest; and setting weight coefficients of each of the isolated trees in combination with diversity measure, modeling a weighted hybrid isolation forest Whiforest, and determining anomalies of WSN data in the samples to be tested by means of the Whiforest model.

2. The method according to claim 1, wherein before modeling the isolated tree set iforest by means of historical data sets collected by sensor nodes based on the isolation forest algorithm, the method further comprises:
dividing the historical data sets collected by the sensor nodes into training sets and test sets.

3. The method according to claim 2, wherein the process of modeling the isolated tree set iforest by means of historical data sets collected by sensor nodes based on the isolation forest algorithm, introducing information of the distance between samples to be tested and respective sample centers thereof to each of leaf nodes of each of isolated trees in the isolated tree set iforest, setting weight coefficients of each of the isolated trees in combination with diversity measure, and modeling the weighted hybrid isolation forest Whiforest comprises:
step 1: modeling each of the isolated trees in the isolated tree set iforest by means of the data of the training sets in the historical data sets, comprising setting a parameter bootstrap sampling number ψ, a forest scale T, a weight coefficient threshold μ, a size of a verification sample set Val_W and a known abnormal sample injection ratio;
step 2: randomly choosing known abnormal samples according to the known abnormal sample injection ratio, and injecting the chosen known abnormal samples to each of the isolated trees in the iforest;
step 3: computing a training sample center Cen-s in the leaf nodes of each of the trees and a distance δ(x) between each of the samples to be tested x in the leaf nodes and the Cen-s, and computing a mean s_{c}(x) of the distance δ(x) in each of the trees in the forest:
s_{c}(x)=E(δ(x))
step 4: computing an abnormal sample center Cen-a in the leaf nodes, computing the distance δₐ(x) between each of the samples to be tested x in the leaf nodes and the above Cen-a, and computing a ratio sₐ(x) of the mean of δ(x) to the mean of δₐ(x) in all isolated trees:
$${s}_{a} ( x ) = \frac{E ( δ ( x ) )}{E ( {δ}_{a} ( x ) )} = \frac{{Mean}_{iforest} ( δ ( x ) )}{{Mean}_{iforest} ( {δ}_{a} ( x ) )}$$
step 5: choosing verification sample sets Val-W according to the historically collected data sets, detecting the verification sample sets Val-W by the above established isolated tree set iforest, and computing diversity between the isolated trees in the forest by means of disagreement measure in combination with an idea of diversity of base classifiers in ensemble learning, so as to obtain a T*T symmetric matrix diversity of which opposite angles are 0, wherein T represents the number of the isolated trees in the isolated tree set iforest;
step 6: summing up a diversity matrix and making a quotient according to a forest scale T to obtain B_{index}, at this time, comparing the B_{index} with a threshold μ, and setting weights as follows:
$$W = \{ \begin{matrix}{B}_{index} + 1 , & if B \geq μ \\ 1 - {B}_{index} , & if B < μ\end{matrix}$$
step 7: setting the weight w1=B_{index}+1 for the tree of which the B_{index} is greater than or equal to μ, setting the weight w2=1−B_{index} for the tree of which the B_{index} is less than μ, multiplying both s_{c}(x) and sₐ(x) variables by w1 and w2, and computing s_{c}(x) and sₐ(x) by the following formulae:
s_{c}(x)=W*δ(x)
δₐ(x)=W*δₐ(x)
step 8: normalizing the original Score(x) of the sample in a current data window and two currently introduced distance-based scores, i.e. {Score,sₐ(x),s_{c}(x)}, by the following normalization formula:
$$\tilde{s} ( x ) = \frac{s ( x ) - min ( s ( x ) )}{max ( s ( x ) ) - min ( s ( x ) )}$$
wherein s(x) represents the above three scores Score, sₐ(x), s_{c}(x), \tilde{s}(x) represents a normalized value, and finally, the above three scores are fused by the following formula to obtain a final window sample anomaly score s_{final}:
s_{final}(x)=α₂*(α₁*\tilde{s}(x)+(1−α₁)*\tilde{s}_{c}(x))+(1−α₂)*\tilde{s}ₐ(x)
step 9: sorting the s_{final} in a descending order, obtaining a data sample having the highest anomaly score according to domain knowledge or referring to the known anomaly number ratio of the original data set, then comparing the data sample with the label of the tested data sample, and computing evaluation indexes related to a detection ratio and a false alarm ratio; and
step 10: if a node detects that there is an abnormal sample in a data window, transferring a sequence number of the abnormal sample to a cluster head node for performing next verification or processing.

4. The method according to claim 3, wherein in the step 4, if a leaf node has no abnormal sample, the abnormal sample center Cen-a is marked as 0.

5. The method according to claim 3, wherein in the step 6, summation of the diversity matrix is summation of columns of the diversity matrix.

6. The method according to claim 3, wherein in the step 1, a termination condition for modeling of the isolated trees is as follows: the samples cannot be divided, i.e., only one data value is comprised, or the data samples are exactly the same, or depth of the isolated trees reaches the maximum log(ψ).

7. The method according to claim 3, wherein in the step 8, the original Score(x) of the sample in the current data window is computed according to the following formula:
$$Score ( x ) = {2}^{- \frac{E ( h ( x ) )}{C ( ψ )}}$$
wherein h(x) represents a path length of the data sample x on a tree, and C(ψ) represents a mean search path length of Itree modeled with the sampling number ψ.

8. The method according to claim 7, wherein the path length of the data sample x on a tree is h(x)=e+C(T.size), and C(T.size) represents a mean path length of a binary tree modeled with T.size pieces of data.

9. A method for monitoring an environment by a wireless sensor network (WSN), wherein the WSN comprises a plurality of sensor nodes, the plurality of sensor nodes are dispersed in the environment to be monitored, and the method comprises: adopting the method for detecting abnormal data in the WSN according to claim 1 to detect abnormal data in the data collected by each of the sensor nodes, and removing the abnormal data to obtain a state of the monitored environment; and
a historical data set collected by each of the sensor nodes in the WSN comprises data of three attributes of temperature, humidity and light intensity.

10. The method according to claim 9, wherein the historical data set collected by each of the sensor nodes further comprises data of a node voltage attribute.

11. A computer device, comprising a memory, a processor and a computer program stored in the memory and capable of running on the processor, wherein when the computer program is executed by the processor, steps of the method according to claim 1 are implemented.
